(19) United States
(12) Patent Application Publication
(10) Pub. No.: US 2025/0046290 A1
(43) Pub. Date: Feb. 6, 2025

(54) SELECTIVE ANTI-SOUND HEADSET

(71) Applicant: ISTANBUL MEDIPOL UNIVERSITESI TEKNOLOJI TRANSFER OFISI ANONIM SIRKETI, Beykoz, Istanbul (TR)

(72) Inventor: Necdet ÖZÇELIK, Beykoz, Istanbul (TR)

(21) Appl. No.: 18/717,657

(22) PCT Filed: Dec. 29, 2021
(86) PCT No.: PCT/TR2021/051583

§ 371 Date: Jun. 7, 2024

(30) Foreign Application Priority Data
Dec. 10, 2021 (TR) 2021/019642

(51) Int. Cl. G10K 11/178; H04R 1/10

(52) U.S. Cl. CPC G10K 11/17837; H04R 1/1041; H04R 1/1083

(57) ABSTRACT

A headset device providing selective sound transmission including a user interface that allows for determination of which sounds will be attenuated or not in the headset device and which stores the sounds recorded and/or selected by the user in a database. A microphone collects external sounds. A processor is provided for determining and analyzing the frequency and amplitude of the sound wave received over the microphone. The processor communicates with the user interface via a communication unit and compares the sounds recorded in the database and the sounds coming from the microphone. The sound is attenuated by producing an anti-sound in the opposite frequency of the sound and sending it to the ear through the speaker if the analyzed sound is a sound desired to be attenuated. Alternately, the sound is sent directly to the ear if the analyzed sound should not to be attenuated.

### TECHNICAL FIELD OF THE INVENTION

The invention relates to a hearing aid that can be placed in the external ear canal providing selective sound transmission to the ear by introducing the warnings that are necessary and may pose a danger if not heard and the sounds of the people whose auditory warning are allowed, to the device while providing active prevention of unwanted and disturbing sounds in the environment where the person rests, sleeps or works.

### STATE OF THE ART OF THE INVENTION (PRIOR ART)

There is a technology called “active noise cancelling (ANC)” in hearing aids and quality headphones today. This technology is a system used to prevent environmental noises during the music and people being listened to. It blocks all sounds except music or sound. Therefore, this system, which is currently used, causes many problems as it also blocks the sounds that the user wants to hear. For example, the user cannot hear the horn of a vehicle that s/he should hear when walking on the road and cannot take precautions against it. Therefore, various accidents may occur.

The abstract of the application number 2021/012117, which emerged as a result of technical research, is as follows: “The present invention relates to sound signal processing and especially to an apparatus and method for improving the perceived quality of sound reproduction by combining Active Noise Cancellation and Perceptual Noise Compensation, for example by improving the perceived quality of sound reproduction through headphones.”

The system relates to an apparatus and method for improving the perceived quality of sound reproduction by combining active noise cancellation and perceptual noise compensation, and it does not mention an embodiment that can provide a solution to the disadvantages mentioned above.

In conclusion, it was deemed necessary to make an improvement in the relevant technical field due to the disadvantages described above and the inadequacy of the existing solutions on the subject.

### OBJECT OF THE INVENTION

The object of the invention is to provide a structure having different technical features that are novel in this field, different from the embodiments used in the known state of art.

The primary object of the invention is to provide a device that enables to hear the sounds such as the phone, doorbell or alarm warning sounds used in the workplace introduced to the device while using in the areas where the sleep is not efficient due to snoring of the person lying next to or the unwanted sounds in the living environment that will prevent resting, and areas cause distraction in the workplace.

An object of the invention is to ensure that individuals with hearing loss can hear emergency warning alerts and sounds of babies during sleep at night.

Another object of the invention is to introduce the doorbell, clock alarm or fire alarm sounds that are desired to be heard while the active noise cancellation system subject to the invention is in full operation or the sound of the person (baby and children living in the house) that is desired to be heard and to ensure that unwanted sounds are not heard by placing a hearing aid in the external ear canal to which these sounds can be loaded very easily by the person.

Ear anatomy is mainly examined in 3 parts;
Auricle and external ear canal
Middle ear (ear drum, middle ear cavity, eustachian tube)
Inner ear (hearing and balance organ)

The device according to the invention is positioned at the entrance of the external ear canal.

The main issues required for realizing the headset device of the invention are as follows:
Voice identification and recording
Noise analysis.
Creating a phone interface
Writing software for voice analysis.
Ear anatomy.
ANC system
Energy supply.
Bluetooth support

The invention is a headset device that can be placed in the external ear canal providing selective sound transmission to the ear by introducing the warnings that are necessary and may pose a danger if not heard and the sounds of the people whose auditory warning are allowed, to the device while providing active prevention of unwanted and disturbing sounds in the environment where the person rests, sleeps or works, characterized in that; it comprises the following:
An user interface that allows determining which sounds will be attenuated or not in the headset device and stores the sounds recorded and/or selected by the user in a database,
A microphone that collects external sounds,
A processor that provides the following:
   Determining and analyzing the frequency and amplitude of the sound wave received over the microphone,
   Communicating with the user interface via the communication unit and comparing the sounds recorded in the database and the sounds coming from the microphone (10),
   Attenuating the sound by producing an anti-sound in the opposite frequency of said sound and giving it to the ear through the speaker if the analyzed sound is the sound desired to be attenuated,
   Giving said sound directly to the ear if the analyzed sound is the sound desired not to be attenuated.

The structural and characteristic features and all the advantages of the invention will be understood more clearly by means of the figures and the detailed description with reference to these figures given below and therefore, the evaluation should be made by taking these figures and the detailed description into consideration.

### FIGURES FOR UNDERSTANDING OF THE INVENTION

FIG. 1 is a representative illustration of the device according to the invention.

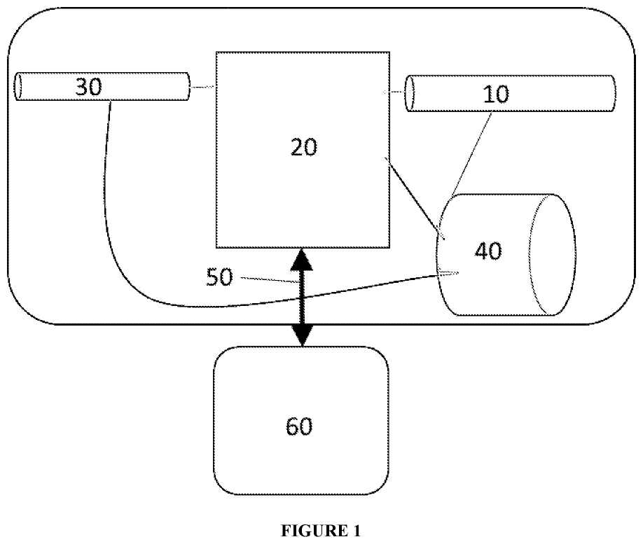

FIG. 2 is a schematic illustration of the method steps performed with the device according to the invention.

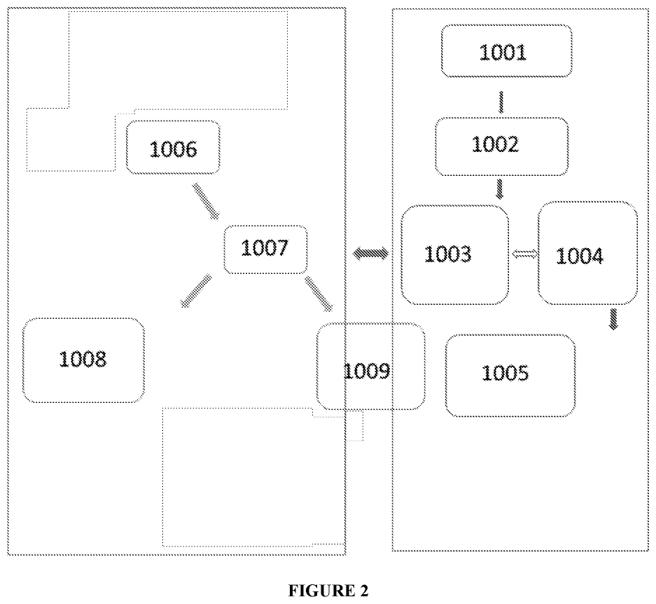

The drawings are not necessarily drawn to scale and details which are not necessary for the understanding of the present invention may be omitted. In addition, elements that are substantially identical or have substantially identical functions are denoted by the same reference signs.

### DESCRIPTION OF THE PART REFERENCES

10. Microphone
20. Processor
30. Speaker
40. Battery
50. Communication unit
60. User interface
1001. Recording unwanted sounds through the user interface (60) or selecting the sounds desired to be heard or unwanted sounds from the recorded sounds,
1002. Analyzing and classifying the recorded sounds in the user interface (60),
1003. Recording sounds in a classified form in the audio database,
1004. Deleting unwanted voice definitions from the audio database by the user,
1005. Communicating by the user interface (60) with the processor (20) in the headset device through the communication unit (50) and accessing by the processor (20) the audio database,
1006. Detecting external sounds with the microphone (10) in the headset device and recording of sounds through the processor (20),
1007. Analyzing the sounds received from the microphone (10) by the processor (20) and comparing it with the sounds in the audio database,
1008. Attenuating the unwanted sound by producing an anti-sound in the opposite frequency of said sound by the processor (20) and giving the produced anti-sound to the ear through the speaker (30) if the processed sound is the sound desired to be attenuated in the user interface (60),
1009. Ensuring that the user can hear the sound without an intervention by the processor (20) if the processed sound is not the sound desired to be attenuated in the user interface (60).

### DETAILED DESCRIPTION OF THE INVENTION

The preferred embodiments of the invention are merely described for a better understanding of the subject matter and without any limiting effect in this detailed description.

The invention relates to a headset device that can be placed in the external ear canal providing selective sound transmission to the ear by introducing the warnings that are necessary and may pose a danger if not heard and the sounds of the people whose auditory warning are allowed, to the device while providing active prevention of unwanted and disturbing sounds in the environment where the person rests, sleeps or works.

The inventive headset device is managed through a user interface (60) and which sounds will or will not be attenuated is selected through the user interface (60). The user interface (60) is preferably located on a mobile device such as a mobile phone, wristwatch, etc., and operates on an application. The commands on the user interface (60) are as follows;
User Login
Audio recording and analysis button
Recorded audio database display
   There is a cross next to the recorded sounds. Previously recorded sounds can be removed from this mark. It can keep the software up to date through the user interface (60) when it is desired to hear at that moment and then given up in this way.

The sounds recorded through the user interface (60) are stored in a database. The user selects the sounds he/she wants to hear and does not want to hear through the user interface (60).

The inventive headset device has a microphone (10) that listens to passively unblockable external sounds and is placed inside the ear cup (outer ear canal). The sounds received over the microphone (10) are transmitted to the processor (20) for analysis. The processor (20) consists of an electronic circuit placed in the ear cup, after detecting the input from the microphone (10), determines the frequency and amplitude of the incoming sound wave with the software in it, that is, it forms a “fingerprint” of the noise.

The headset device collects the surrounding sounds through the microphone (10) preferably every two minutes from the moment of wearing it and records them by the processor (20). The processor (20) in the inventive headset device communicates with the user interface (60), preferably with the bluetooth communication unit (50). The processor (20) compares the sounds coming from the microphone (10) with the sounds specified through the user interface (60). An anti-sound is produced by the processor (20) in the opposite frequency of said sound (a new wave is created that is out of phase 180 degrees with the noise-related waves) if the processed sound is the sound desired to be attenuated in the user interface (60). The produced anti-sound is given to the ear via the speaker (30) (These sound waves are provided by small oscillator circuits in the earphones). Thus, the sounds produced by the headset device with the external sound are reset on the basis of frequency and the user is prevented from hearing these sounds. No intervention is made by the processor (20) and it is ensured that the user can hear if the processed sound is not the sound desired to be attenuated in the user interface (60).

FFT (Fast Fourier Transform) is performed instantly for the analysis of the sounds in the processor (20). Snoring noise, environmental noises, etc. are evaluated as noise and prevented with sounds produced in 180 degree phase changes. It is ensured that if the user has a hearing loss the patients can hear the alarm sounds and other sounds that they need to hear by giving sounds in the frequency zones determined by the user in the user interface (60) and less affected by the hearing loss.

The energy of the headset device of the invention is provided through the battery (40). The battery (40) is rechargeable.

The method steps for attenuating the unwanted sound in the headset device of the invention are as follows:
Recording unwanted sounds through the user interface (60) or selecting the sounds desired to be heard or unwanted sounds from the recorded sounds (1001),
Analyzing and classifying the recorded sounds in the user interface (60) (1002),
Recording sounds in a classified form in the audio database (1003),
Deleting unwanted voice definitions from the audio database by the user (1004),
Communicating by the user interface (60) with the processor (20) in the headset device through the communication unit (50) and accessing by the processor (20) the audio database (1005),
Detecting external sounds with the microphone (10) in the headset device and recording of sounds through the processor (20) (1006),
Analyzing the sounds received from the microphone (10) by the processor (20) and comparing it with the sounds in the audio database (1007),
Attenuating the unwanted sound by producing an anti-sound in the opposite frequency of said sound by the processor (20) and giving the produced anti-sound to the ear through the speaker (30) if the processed sound is the sound desired to be attenuated in the user interface (60) (1008),
Ensuring that the user can hear the sound without an intervention by the processor (20) if the processed sound is not the sound desired to be attenuated in the user interface (60) (1009).

1. A headset device that can be placed in the external ear canal providing selective sound transmission to the ear by introducing the warnings that are necessary and may pose a danger if not heard and the sounds of the people whose auditory warning are allowed, to the device while providing active prevention of unwanted and disturbing sounds in the environment where the person rests, sleeps or works, the headset device comprising:
a user interface that allows determining which sounds will be attenuated or not in the headset device and stores the sounds recorded and/or selected by the user in a database,
a microphone that collects external sounds,
a processor that provides for the following:
determining and analyzing the frequency and amplitude of the sound wave received over the microphone,
communicating with the user interface via a communication unit and comparing the sounds recorded in the database and the sounds coming from the microphone,
attenuating the sound by producing an anti-sound in the opposite frequency of said sound and giving it to the ear through the speaker if the analyzed sound is the sound desired to be attenuated, and
giving said sound directly to the ear if the analyzed sound is the sound desired not to be attenuated.

2. The headset device according to claim 1, wherein said communication unit includes bluetooth technology.

3. The headset device according to claim 1, comprising a battery that supplies the headset with the necessary energy.

4. The headset device according to claim 1, wherein said user interface includes user input, audio recording and analysis button and recorded audio database screen.

5. A method of attenuating unwanted sounds by a headset device that can be placed in the external ear canal providing selective sound transmission to the ear by introducing the warnings that are necessary and may pose a danger if not heard and the sounds of the people whose auditory warning are allowed, to the device while providing active prevention of unwanted and disturbing sounds in the environment where the person rests, sleeps or works, the method comprising:
recording unwanted sounds through a user interface or selecting sounds desired to be heard or unwanted sounds from the recorded sounds (1001),
analyzing and classifying the recorded sounds in the user interface (1002),
recording sounds in a classified form in an audio database (1003),
deleting unwanted voice definitions from the audio database by the user (1004),
communicating by the user interface with a processor in the headset device through a communication unit and accessing by a processor the audio database (1005),
detecting external sounds with a microphone in the headset device and recording of sounds through the processor (1006),
analyzing the sounds received from the microphone by the processor and comparing it with the sounds in the audio database (1007),
attenuating the unwanted sound by producing an anti-sound in the opposite frequency of said sound by the processor and giving the produced anti-sound to the ear through a speaker if the processed sound is the sound desired to be attenuated in the user interface (1008), and
ensuring that the user can hear the sound without an intervention by the processor if the processed sound is not the sound desired to be attenuated in the user interface (1009).

6. A method according to claim 5, comprising a step in which the patients can hear the alarm sounds and other sounds that they need to hear by giving sounds in the frequency zones determined by the user in the user interface and less affected by the hearing loss if the user has a hearing loss.
